(19) United States
(12) Patent Application Publication
(10) Pub. No.: US 2025/0074226 A1
(43) Pub. Date: Mar. 6, 2025

(54) ELECTRIFIED VEHICLE AND METHOD FOR CONTROLLING CHARGING AND DISCHARGING OPERATIONS OF THE SAME

(71) Applicants: Hyundai Motor Company, Seoul (KR); Kia Corporation, Seoul (KR)

(72) Inventors: Do Hyeon HAM, Goyang-si (KR); In Ho KIM, Seoul (KR); Ho Jun SHIN, Incheon (KR); Choul Woo JUNG, Hwaseong-si (KR)

(21) Appl. No.: 18/656,891

(22) Filed: May 7, 2024

(30) Foreign Application Priority Data
Sep. 4, 2023 (KR) 10-2023-0117083

(51) Int. Cl. B60L 53/22; B60L 50/51; B60L 53/24; H02M 7/5387

(52) U.S. Cl. CPC B60L 53/22; B60L 50/51; B60L 53/24; H02M 7/53871; B60L 2210/40; B60L 2240/547

(57) ABSTRACT

An electrified vehicle and a method for controlling charging and discharging operation of the same are disclosed. The electrified vehicle includes an AC connector, a motor connected to a first AC terminal at a neutral point thereof, an inverter including a plurality of first legs connected between two DC terminals, respective arms of the plurality of first legs being connected to corresponding ones of a plurality of windings of the motor, a second leg connected, at both ends thereof, to the two DC terminals while being connected, at an arm thereof, to a second AC terminal, and a controller configured to control switching elements of the first leg and the second leg.

### CROSS-REFERENCE TO RELATED APPLICATION

This application claims the benefit of Korean Patent Application No. 10-2023-0117083 filed on Sep. 4, 2023, in the Korean Intellectual Property Office, the disclosure of which is incorporated herein by reference.

### TECHNICAL FIELD

The present disclosure relates to an electrified vehicle including an inverter configured to convert AC power into DC power during charging or discharging of a battery, and a method for controlling charging and discharging operations of the same.

### BACKGROUND

A conventional electrified vehicle is equipped with a motor configured to generate driving power and a battery configured to supply electric power necessary for motor operation. The vehicle is also equipped with an on-board charger (OBC) configured to recharge the vehicle's battery using standard AC power.

The on-board charger (OBC) performs operations related to converting an AC voltage into a DC voltage to recharge the vehicle's battery. In addition, the OBC may perform operations related to converting DC power from the battery during discharge.

Typically, an on-board charger (OBC) consists of a power factor correction circuit (PFC) configured to correct a power factor of standard AC power and a DC/DC converter configured to convert the voltage from a link capacitor into the DC voltage required for the vehicle's battery.

### SUMMARY

The present disclosure is directed to an electrified vehicle capable of performing the function of the above-mentioned on-board charger (OBC) through an inverter equipped therein, and a method for controlling charging and discharging operations of the same.

According to an aspect of the present disclosure, an electrified vehicle can include an AC connector electrically connected to a first AC terminal and a second AC terminal, a motor including a plurality of windings, the motor being connected to the first AC terminal at a neutral point thereof formed by the plurality of windings, an inverter including two DC terminals, and a plurality of first legs connected between the two DC terminals, respective arms of the plurality of first legs being connected to corresponding ones of the plurality of windings, a second leg connected, at both ends thereof, to the two DC terminals while being connected, at an arm thereof, to the second AC terminal, and a controller configured to control switching elements of the first legs and the second leg.

The AC connector may be selectively connected to an AC power source.

The controller may control a plurality of switching elements connected to remaining ones of the plurality of first legs, except for one of the plurality of first legs, to be turned off under a condition that the AC power source is connected to the AC connector.

The controller may control the switching elements of the one of the plurality of first legs and the switching elements of the second leg to be switched.

The AC connector may include a capacitor connected between the first AC terminal and the second AC terminal.

The AC connector may further include a resistor connected to the capacitor in series between the first AC terminal and the second AC terminal.

The electrified vehicle may further include a switch configured to selectively interconnect the neutral point and the first AC terminal in accordance with a turn-on/off state thereof.

The controller may turn on the switch under a condition that the AC power source is connected to the AC connector.

The controller may control the switching elements of the plurality of first legs to be switched under a condition that the AC power source is not connected to the AC connector.

The controller may control the switching elements of the plurality of first legs to be switched in accordance with a driving request of the motor.

According to another aspect of the present disclosure, a method for controlling charging and discharging operations of the electrified vehicle can include turning off the switching elements of remaining ones of the plurality of first legs of the inverter, except for one of the plurality of first legs, under a condition that the AC power source is connected to the AC connector, by the controller, and switching the switching elements of the one first leg and the switching elements of the second leg by the controller.

The method may further include turning on a switch configured to interconnect the neutral point formed by the plurality of windings of the motor and the first AC terminal by the controller, before the turning off.

The switching the switching elements of the one first leg and the switching elements of the second leg may include switching the switching elements of the one first leg and the switching elements of the second leg in accordance with a charging request or a discharging request of the battery by the controller.

The method may further include performing switching the switching elements of the plurality of first legs under a condition that the AC power source is not connected to the AC connector by the controller.

The switching the switching elements of the plurality of first legs may include switching the switching elements of the plurality of first legs in accordance with a driving request of the motor by the controller.

According to various implementations of the present disclosure as described above, it may be possible to convert AC power into DC power during a charging operation of the battery and to convert DC power into AC power during a discharging operation of the battery through the driving inverter equipped in the electrified vehicle.

Accordingly, a separate on-board charger (OBC) for charging and discharging operations of the battery may be eliminated.

In addition, since power conversion is performed through an inverter having a relatively great current capacity, it may be possible to reduce damage caused by overcurrent during power conversion and to enhance charging and discharging performance of the battery.

### BRIEF DESCRIPTION OF THE DRAWINGS

FIG. 1 is a diagram illustrating an example of a circuit configuration of an electrified vehicle.

FIG. 2 is a diagram illustrating an example of a circuit of the electrified vehicle associated with charging and discharging operations of the electrified vehicle.

FIG. 3 is an equivalent circuit diagram of the circuit of FIG. 2.

FIGS. 4A and 4B are graphs illustrating exemplary charging and discharging operations of the electrified vehicle.

FIG. 5 is a flowchart illustrating an example of a method for controlling charging and discharging operations of the electrified vehicle.

### DETAILED DESCRIPTION

In this specification, the term “unit” or “control unit” used in specific terminology such as a motor control unit (MCU), a hybrid control unit (HCU) or the like is only a term widely used for designation of a controller for controlling a particular function of a vehicle and, as such, does not mean a generic functional unit.

The controller may include a communication device configured to communicate with another controller or a sensor for control of a function to be performed thereby, a memory configured to store an operating system, logic commands, input/output information, etc., and at least one processor configured to execute discrimination, calculation, determination, etc. required for control of the function to be performed.

An electrified vehicle of the present disclosure and a method for controlling charging and discharging operations of the same propose that an inverter provided for driving operation perform conversion between AC power and DC power during charging and discharging operations of a battery, to substitute an on-board charger (OBC) therewith, thereby being capable of achieving simplification of the configuration of the vehicle while achieving an enhancement in charging and discharging performance of the vehicle.

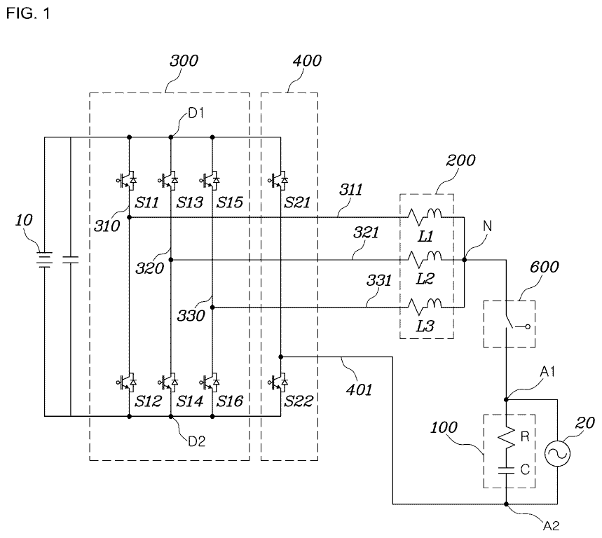

Hereinafter, a configuration of an electrified vehicle will be described with reference to FIGS. 1 to 3, before describing a method for controlling charging and discharging operations of the electrified vehicle.

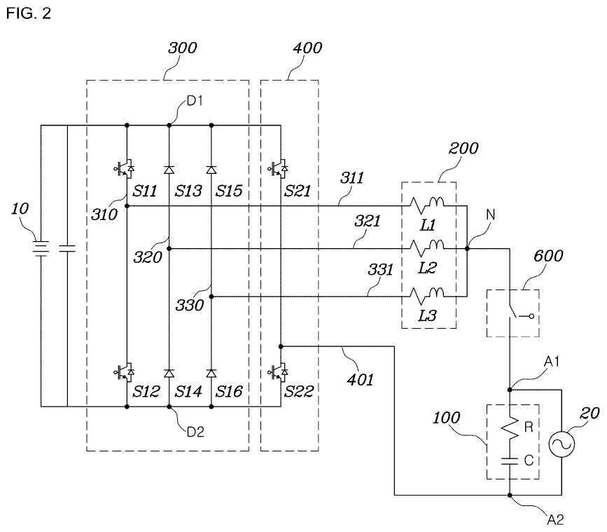

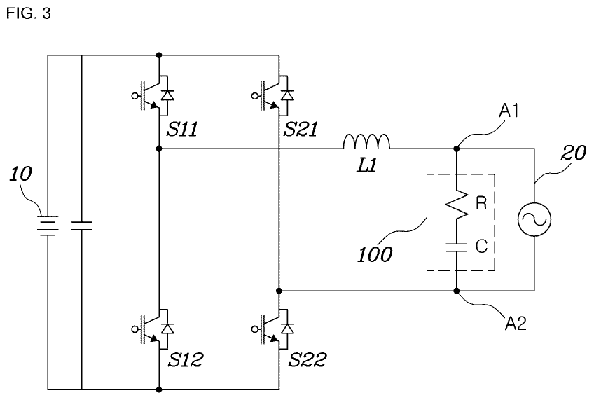

FIG. 1 is a circuit diagram showing a circuit configuration of an electrified vehicle. FIG. 2 is a circuit diagram showing a circuit of the electrified vehicle associated with charging and discharging operations of the electrified vehicle. FIG. 3 is an equivalent circuit diagram of the circuit of FIG. 2.

Referring to FIG. 1, the electrified vehicle includes an AC connector 100, a motor 200, an inverter 300, a second leg 400, a controller 500, and a switch 600. Of course, FIG. 1 mainly shows constituent elements associated with description of the implementation of the present disclosure, but the charging and discharging apparatus may be practically implemented through inclusion of a greater or smaller number of constituent elements than that of the shown constituent elements. Next, each constituent element will be described in detail.

First, the AC connector 100 is electrically connected to a first AC terminal A1 and a second AC terminal A2.

The motor 200 includes a plurality of windings L1 to L3, and is connected to the first AC terminal A1 at a neutral point N thereof formed by the plurality of windings L1 to L3.

The inverter 300 includes two DC terminals D1 and D2, and a plurality of first legs 310, 320, and 330 connected between the two DC terminals D1 and D2. Respective arms 311, 321, and 331 of the plurality of first legs 310, 320, and 330 are connected to corresponding ones of the plurality of windings L1 to L3. In this case, the two DC terminals D1 and D2 may be connected to a positive terminal of the battery 10.

In more detail, a plurality of switching elements S11 to S16 may be connected to the first legs 310, 320, and 330, and respective arms 311, 321, and 331 of the first legs 310, 320, and 330 may be formed between corresponding ones of the switching elements S11 to S16.

For example, the switching elements S11 and S12 may be connected to the 1-1-th leg 310, and the 1-1-th leg 310 may be connected to the winding L1 of the motor 200 through the arm 311 between the switching elements S11 and S12. The switching elements S13 and S14 may be connected to the 1-2-th leg 320, and the 1-2-th leg 320 may be connected to the winding L2 of the motor 200 through the arm 321 between the switching elements S13 and S14. Similarly, the switching elements S15 and S16 may be connected to the 1-3-th leg 330, and the 1-3-th leg 330 may be connected to the winding L3 of the motor 200 through the arm 331 between the switching elements S15 and S16.

Corresponding ones of the plurality of switching elements S11 to S16 included in respective first legs 310, 320, and 330 may be complementarily switched, to adjust the direction of current input to the battery 10 connected to the two DC terminals D1 and D2 of the switching elements S11 to S16 or to adjust the direction of current input to the side of the first AC terminal A1 and the second AC terminal A2.

Meanwhile, the electrified vehicle can further include a second leg 400 connected, at both ends thereof, to the two DC terminals D1 and D2 while being connected, at an arm 401 thereof, to the second AC terminal A2, in addition to the first legs 310, 320, and 330 of the inverter 300.

A plurality of switching elements S21 and S22 may be connected to the second leg 400, and the second leg 400 may be connected to the second AC terminal A2 through the arm 401 between the plurality of switching elements S21 and S22. The second leg 400 may be connected to the battery 10 through the two DC terminals D1 and D2 connected thereto, and may adjust the direction of current input to the battery 10 or the direction of current input to the side of the first AC terminal A1 and the second AC terminal A2, together with the plurality of first legs 310, 320, and 330 of the inverter 300.

Each of the switching elements S11 to S16 of the inverter 300 and the switching elements S21 and S22 of the second leg 400 may be embodied as an IGBT or a MOSFET, without being limited thereto.

Turn-on/off states of the switching elements S11 to S16 of the inverter 300 and the switching elements S21 and S22 of the second leg 400 may be controlled by the controller 500. The controller 500 may be implemented through inclusion of at least a part of a vehicle charging management system (VCMS), a battery management system (BMS), a motor control unit (MCU), or a vehicle control unit (VCU), or may be implemented through inclusion of a separate configuration under the condition that the separate configuration performs cooperative control together with the above-described configurations. However, such implementation is only illustrative, and the implementation type of the controller applicable to implementations of the present disclosure is not limited to the above-described implementation types.

Meanwhile, an AC power source may be selectively connected to the AC connector 100. The AC power source may be embodied as, for example, a system power source or the like.

The controller 500 may control a plurality of switching elements connected to remaining ones of the first legs 310, 320, and 330, except for one of the first legs 310, 320, and 330, to be turned off under the condition that the AC power source 20 is connected to the AC connector 100.

For example, under the condition that the AC power source 20 is connected to the AC connector 100, the controller 500 may control the switching elements S11 and S12 of the 1-1-th leg 310 to be switched through repetition of turning-on/off and may control the switching elements S13 and S14 of the 1-2-th leg 320 and the switching elements S15 and S16 of the 1-3-th leg 330 to be turned off. In this case, the circuit of the electrified vehicle may be represented as shown in FIG. 2 and, as such, may have an equivalent circuit configuration as shown in FIG. 3.

That is, under the condition that the AC power source 20 is connected to the AC connector 100, the controller 500 may control the switching elements of the inverter 300 such that the inverter 300 and the second leg 400 form a full bridge circuit and, as such, the inverter 300 and the second leg 400 may function as a single-phase inverter.

In this case, the controller 500 may control switching of the switching elements of one of the plurality of first legs 310, 320, and 330 and the switching elements S21 and S22 of the second leg 400. In particular, the controller 500 may control the above-described switching in accordance with a charging request or a discharging request of the battery 10.

Meanwhile, the AC connector 100 may further include a capacitor C connected between the first AC terminal A1 and the second AC terminal A2. In addition, the AC connector 100 may further include a resistor R connected to the capacitor C in series between the first AC terminal A1 and the second AC terminal A2.

That is, a capacitor filter may be formed at the AC connector 100. In this case, the AC connector 100 may smooth a DC voltage through charging and discharging operations of the capacitor C, thereby achieving a reduction in ripple. Meanwhile, the switch 600 may be disposed between the neutral point N and the first AC terminal A1, and may selectively interconnect the neutral point N and the first AC terminal A1 in accordance with a turn-on/off state thereof. The switch 600 may be embodied as, for example, a relay, without being limited thereto.

In this case, the controller 500 may turn on the switch 600 under the condition that the AC power source 20 is connected to the AC connector 100, thereby electrically interconnecting the AC power source 20 and the battery 10. In a state in which the AC power source 20 and the battery 10 are interconnected, the battery 10 may receive electric power from the AC power source 20, to be recharged with the received electric power, or may discharge electric power stored therein, to supply the discharged electric power to the side of the AC power source 20.

During charging of the battery 10, the inverter 300 and the second leg 400 may convert an AC voltage output from the AC power source 20 into a DC voltage, and may then transmit the converted DC voltage to the side of the positive terminal of the battery 10. On the other hand, during discharge of the battery 10, the inverter 300 and the second leg 400 may alternately transmit a DC voltage output from the battery 10 to the first AC terminal A1 and the second AC terminal A2.

Referring to FIG. 1, for example, during charging of the battery 10, current input to the first AC terminal A1 from the AC power source 20 may be input to the positive terminal of the battery 10 along the first AC terminal A1—the switch 600, the winding L1—the arm 311 of the 1-1-th leg 310—the switching element S11, and current input to the second AC terminal A2 from the AC power source 20 may be input to the positive terminal of the battery 10 along the arm 401 of the second leg 400—the switching element S21.

On the other hand, during discharge of the battery 10, current output from the positive terminal of the battery 10 may be input to the first AC terminal A2 along the switching element S11—the arm 311 of the 1-1-th leg 310—the winding L1—the switch 600 or may be input to the second AC terminal A2 along the switching element S21—the arm 401 of the second leg 400.

Meanwhile, under the condition that the AC power source 20 is not connected to the AC connector 100, the controller 500 may control the switching elements S11 to S16 of the plurality of first legs 310 to be switched. That is, the inverter 300 may function as an inverter for three-phase driving under the condition that the AC power source 20 is not connected to the AC connector 100. The controller 500 may control switching states of the switching elements S11 to S16 of the inverter 300 in accordance with a driving request of the motor 200.

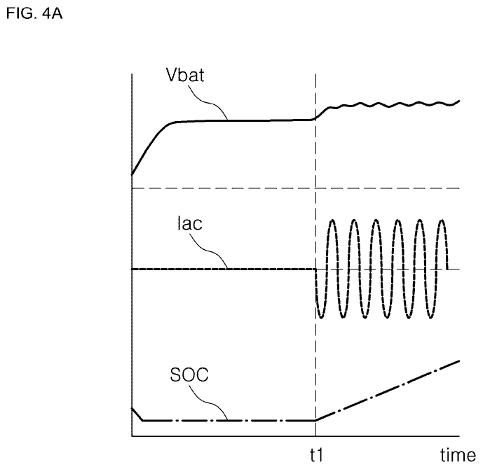

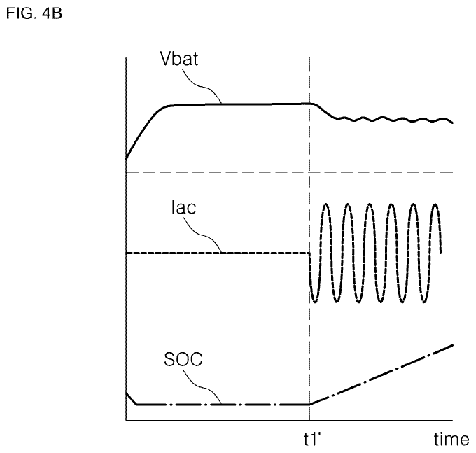

Hereinafter, procedures in which the battery 10 is recharged and discharged through the inverter 300 and the second leg 400 will be described with reference to FIGS. 4A and 4B.

FIGS. 4A and 4B are graphs explaining charging and discharging operations of the electrified vehicle.

In FIGS. 4A and 4B, graphs each having a vertical axis representing a voltage Vbat of the battery 10, current lac of the AC power source 20, and a state of charge (SOC) of the battery 10 while having a horizontal axis representing a time in charging and discharging operations of the battery 10 are shown.

First, referring to FIG. 4A, variations in the voltage Vbat of the battery 10, the current lac of the AC power source 20, and the SOC of the battery 10 during a charging operation of the battery 10 are shown.

When charging control for the battery 10 is begun at a time t1, the AC power source 20 outputs AC current repeatedly changed in direction, and the voltage Vbat of the battery 10 may be increased while having a small amplitude through power conversion of the inverter 300 and the second leg 400. During this procedure, the SOC of the battery 10 is continuously increased.

Next, referring to FIG. 4B, variations in the voltage Vbat of the battery 10, the current lac of the AC power source 20, and the SOC of the battery 10 during a discharging operation of the battery 10 are shown.

When discharging control for the battery 10 is begun at a time t1′, the voltage Vbat of the battery 10 may be decreased while having a small amplitude through power conversion of the inverter 300 and the second leg 400, and AC current repeatedly changed in direction is input to the AC power source 20. During this procedure, the SOC of the battery 10 is continuously decreased.

As shown in FIGS. 4A and 4B, the inverter 300 and the second leg 400 may perform the function of an on-board charger (OBC) configured to recharge the battery 10 with power received from the AC power source 20 or to supply power of the battery 10 to the AC power source 20 and, as such, the electrified vehicle may eliminate provision of a separate on-board charger (OBC).

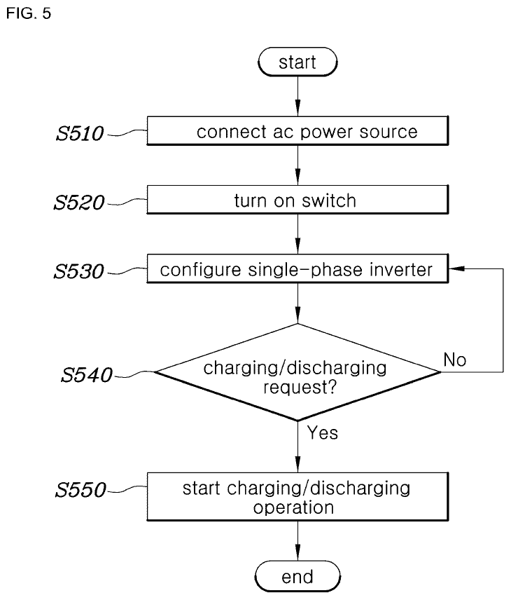

FIG. 5 is a flowchart explaining a method for controlling charging and discharging operations of the electrified vehicle.

Referring to FIG. 5, first, the AC power source 20 is connected to the AC connector 100 (S510). In this case, the controller 500 may turn on the switch 600 configured to selectively interconnect the first AC terminal A1 and the neutral point N in accordance with a turn-on state thereof (S520), thereby electrically interconnecting the battery 10 and the AC power source 20.

In addition, the controller 500 may turn off the switching elements of remaining ones of the plurality of first legs 310, 320, and 330, except for one of the plurality of first legs 310, 320, and 330, thereby shorting the remaining ones of the plurality of first legs 310, 320, and 330, except for the one of the plurality of first legs 310, 320, and 330. Thus, a single-phase inverter may be configured (S530).

When a charging request or a discharging request is generated in the above-described state (“Yes” in S540), the controller 500 may switch the switching elements of the one of the first legs 310, 320, and 330, which is not shorted, thereby enabling a charging operation or a discharging operation of the battery 10 to be begun (S550).

In some implementations, it may be possible to convert AC power into DC power during a charging operation of a battery and to convert DC power into AC power during a discharging operation of the battery through a driving inverter equipped in an electrified vehicle.

Accordingly, a separate on-board charger (OBC) for charging and discharging operations of the battery may be eliminated.

In addition, since power conversion is performed through an inverter having a relatively great current capacity, it may be possible to reduce damage caused by overcurrent during power conversion and to enhance charging and discharging performance of the battery.

What is claimed is:

1. An electrified vehicle comprising:
an AC connector electrically connected to a first AC terminal and a second AC terminal;
a motor comprising a plurality of windings, the motor being connected to the first AC terminal at a neutral point defined by the plurality of windings;
an inverter comprising (i) two DC terminals and (ii) a plurality of first legs connected between the two DC terminals, each leg of the plurality of first legs having an arm connected to a corresponding wingding among the plurality of windings;
a second leg connected to the two DC terminals and having an arm connected to the second AC terminal; and
a controller configured to control a plurality of switching elements of each of the plurality of first legs and the second leg.

2. The electrified vehicle according to claim 1, wherein the AC connector is selectively connected to an AC power source.

3. The electrified vehicle according to claim 2, wherein the controller is configured to, based on the AC power source being connected to the AC connector, deactivate a first set of switching elements connected to a subset of the plurality of first legs and maintain a plurality of switching elements of one leg of the plurality of first legs to be active.

4. The electrified vehicle according to claim 3, wherein the controller is configured to, based on the AC power source being connected to the AC connector, switch the plurality of switching elements of the one leg of the plurality of first legs and the plurality of switching elements of the second leg.

5. The electrified vehicle according to claim 2, wherein the AC connector comprises a capacitor connected between the first AC terminal and the second AC terminal.

6. The electrified vehicle according to claim 5, wherein the AC connector further comprises a resistor connected in series with the capacitor between the first AC terminal and the second AC terminal.

7. The electrified vehicle according to claim 2, further comprising:
a switch configured to, based on a turn-on/off state of the switch, selectively interconnect the neutral point and the first AC terminal.

8. The electrified vehicle according to claim 7, wherein the controller is configured to, based on the AC power source being connected to the AC connector, turn on the switch.

9. The electrified vehicle according to claim 2, wherein the controller is configured to, based on the AC power source being disconnected from the AC connector, control the plurality of switching elements of the plurality of first legs to be switched.

10. The electrified vehicle according to claim 9, wherein the controller is configured to, based on a driving request of the motor, control the plurality of switching elements of the plurality of first legs to be switched.

11. A method for controlling an electrified vehicle, the method comprising:
deactivating, based on an AC power source being connected to an AC connector, a first set of switching elements of a subset of a plurality of first legs of an inverter of the electrified vehicle, and maintaining a plurality of switching elements of one leg of the plurality of first legs to be active, by a controller; and
switching the plurality of switching elements of the one leg of the plurality of first legs and a plurality of switching elements of a second leg of the electrified vehicle, by the controller.

12. The method according to claim 11, further comprising:
turning on a switch configured to interconnect a neutral point defined by a plurality of windings of a motor and a first AC terminal by the controller, before the switch being turned off.

13. The method according to claim 11, wherein switching the plurality of switching elements of the one leg of the plurality of first legs and the plurality of switching elements of the second leg comprises:
switching, based on a charging request or a discharging request of a battery, the plurality of switching elements of the one leg of the plurality of first legs and the plurality of switching elements of the second leg, by the controller.

14. The method according to claim 11, further comprising:
switching, based on the AC power source being disconnected from the AC connector, the plurality of switching elements of the plurality of first legs, by the controller.

15. The method according to claim 14, wherein switching the plurality of switching elements of the plurality of first legs comprises switching, based on a driving request of a motor, the plurality of switching elements of the plurality of first legs, by the controller.
